(19) United States
(12) Patent Application Publication
(10) Pub. No.: US 2017/0017409 A1
(43) Pub. Date: Jan. 19, 2017

(54) MEMORY SYSTEM

(71) Applicant: SK hynix Inc., Gyeonggi-do (KR)

(72) Inventor: Hae-Gi CHOI, Gyeonggi-do (KR)

(21) Appl. No.: 14/959,772

(22) Filed: Dec. 4, 2015

(30) Foreign Application Priority Data
Jul. 13, 2015 (KR) 10-2015-0099045

(51) Int. Cl. G06F 3/06; G06F 9/30

(52) U.S. Cl. CPC G06F 3/0611; G06F 9/3004; G06F 3/065; G06F 3/068

(57) ABSTRACT

A memory system includes a memory device including a first block group and a second block group; and a controller suitable for storing first data in the first block group, and storing second data in the second block group. The first data may be provided within a preset period of time measured from occurrence of a preset event, and the second data may be provided after the preset period of time is expired.

### CROSS-REFERENCE TO RELATED APPLICATIONS

The application claims priority of Korean Patent Application No. 10-2015-0099045, filed on Jul. 13, 2015, which is incorporated herein by reference in its entirety.

### BACKGROUND

1. Field

Various embodiments of the invention relate to semiconductor technology, and more particularly, to a memory system including a semiconductor memory device and a method of operation thereof.

2. Description of the Related Art

The computer environment paradigm has shifted to ubiquitous computing systems that can be used anytime and anywhere. As a result use of portable electronic devices such as mobile phones, digital cameras, and notebook computers continues to increase rapidly. Portable electronic devices generally use a memory system having one or more semiconductor memory devices. A semiconductor memory device may be used as the main or an auxiliary memory device of a portable electronic device.

Semiconductor memory devices provide excellent stability, durability, high information access speed, and low power consumption, since they have no moving parts. Examples of semiconductor memory devices having such advantages include universal serial bus (USB) memory devices, memory cards having various interfaces, and solid state drives (SSD

### SUMMARY

Various embodiments are directed to a memory system capable of efficiently classifying data inputted or retrieved from a host according to the passage of a time from the time point at which a preset event has occurred.

In an embodiment, a memory system may include: a memory device including a first block group and a second block group; and a controller suitable for storing first data in the first block group, and storing second data in the second block group. The first data may be provided within a preset period of time measured from occurrence of a preset event, and the second data may be provided after the preset period of time measured from occurrence of the preset event is expired.

The controller may read out third data by preferentially searching for the third data in the first block group and then in the second block group. The controller may read out fourth data by preferentially searching for the fourth data in the second block group and then in the first block group. The third data may be read out within the preset period of time measured from occurrence of the preset event, and the fourth data may be read out after the preset period of time measured from occurrence of the preset event is expired.

The controller may separately manage a first address for the first and third data and a second address for the second and fourth data.

The preset event may be a power-up event.

The preset event may be a wake-up event.

The preset event may be start of a predetermined operation.

The first block group may store the first and third data with higher reliability than the second block group stores the second and fourth data.

The first block group may include a single level cell, and the second block group may include a multilevel cell.

The first block group may be a cold block group, and the second block group may be a hot block group.

The first and third data may be used during a boosting operation of an operating system, and the second and fourth data may be utility data executed in a background during a normal operation of the operating system or user data selectively executed in the normal operation of the operating system.

In another embodiment, a memory system may include: a first memory device; a second memory device; and a controller suitable for storing first data in the first memory device, and storing second data in the second memory device. The first data may be provided within a preset period of time measured from the occurrence of a preset event. The second data may be provided after the preset period of time measured from the occurrence of the preset event is expired.

The controller may read out third data by preferentially searching for the third data in the first memory device and then in the second memory device. The controller may read out fourth data by preferentially searching for the fourth data in the second memory device and then in the first memory device. The third data may be read out within the preset period of time measured from occurrence of the preset event, and the fourth data may be read out after the preset period of time measured from occurrence of the preset event is expired.

The controller may separately manage a first address for the first and third data and a second address for the second and fourth data.

The preset event may be a power-up event.

The preset event may be a wake-up event.

The preset event may be start of a predetermined operation.

The first memory device may store the first and third data with higher reliability than the second memory device stores the second and fourth data.

The first memory device may include a single level cell, and the second memory device may include a multilevel cell.

The first memory device may have higher operation speed than the second memory device.

The first and third data may be used during a boosting operation of an operating system, and the second and fourth data may be utility data executed in a background during a normal operation of the operating system or user data selectively executed in the normal operation of the operating system.

According to the described embodiments, data inputted or retrieved from a host within a preset period of time measured from a time point at which a preset event occurs and data inputted or retrieved from the host after the preset period of time is expired, may be stored in different memory spaces. Consequently, it is possible to more readily identify the type of data inputted or retrieved from the host, thus facilitating data management.

### BRIEF DESCRIPTION OF THE DRAWINGS

FIG. 1 is a diagram illustrating a data processing system including a memory system, according to an embodiment of the present invention.

FIG. 2 is a diagram illustrating a memory device in, according to an embodiment of the present invention.

FIG. 3 is a circuit diagram illustrating a memory block in a memory device according to an embodiment of the present invention.

FIGS. 4 to 11 are diagrams schematically illustrating various aspects of the memory device shown in FIG. 2, according to an embodiment of the present invention.

FIGS. 12A to 12D are diagrams illustrating an operation of a memory system, according to an embodiment of the present invention.

FIGS. 13A and 13B are diagrams illustrating a memory system according to an embodiment of the present invention.

### DETAILED DESCRIPTION

Various embodiments will be described below in more detail with reference to the accompanying drawings. The invention may, however, be embodied in different forms and should not be construed as limited to the embodiments set forth herein. Rather, these embodiments are provided so that this disclosure will be thorough and complete. Throughout the disclosure, like reference numerals refer to like parts throughout the various figures and embodiments of the invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween. Furthermore, when it is described that one “comprises” (or “includes”) or “has” some elements, it should be understood that it may comprise (or include) or have other elements as well as those elements if there is no specific limitation. The terms of singular form may include plural forms unless stated otherwise.

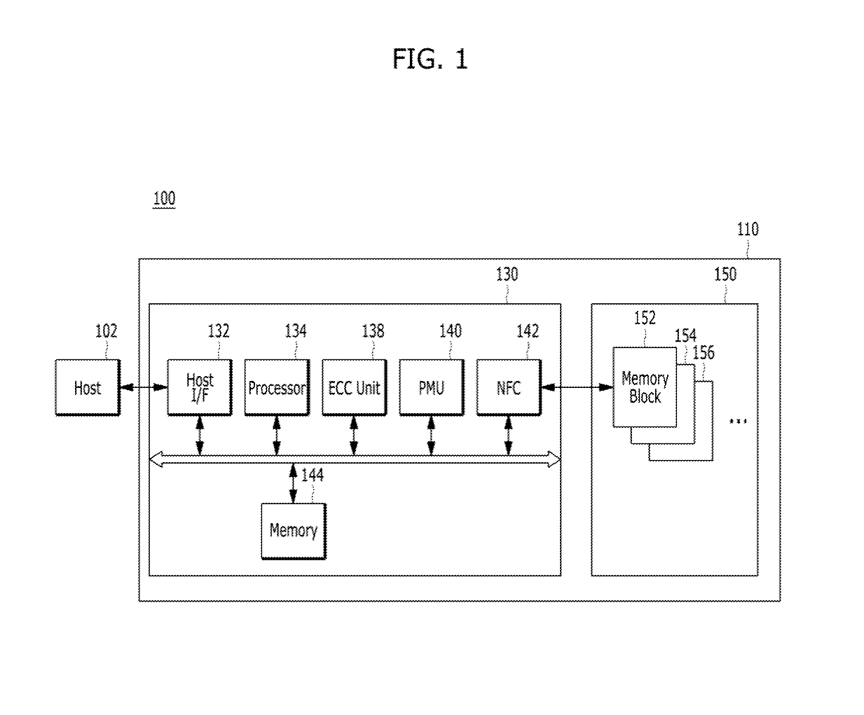

FIG. 1 is a block diagram illustrating a data processing system including a memory system according to an embodiment of the invention.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV, a projector and the like.

The memory system 110 may operate in response to a request from the host 102, and for example, store data to be accessed by the host 102. For example, the memory system 110 may be used as a main memory system or an auxiliary memory system of the host 102. The memory system 110 may be implemented with any one of various types of storage devices, which may be electrically coupled with the host 102, according to a protocol of a host interface. Examples suitable of storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device such as a solid state drive (SSD). When the memory system 110 is used as a SSD, the operation speed of the host 102 that is electrically coupled with the memory system 110 may be significantly increased.

The controller 130 and the memory device 150 may be integrated into a semiconductor device and be configured as a memory card. The controller 130 and the memory card 150 may be integrated into a semiconductor device and be configured as a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For instance, the memory system 110 may be configured as part of a computer, an ultra-mobile PC (UMPC) a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

The memory device 150 of the memory system 110 may retain stored data when power supply is interrupted, for example, the memory device may store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. For example, the memory device may have any other suitable structure. The controller 130 may control overall operations of the memory device 150, such as read, write, program and erase operations. For example, the controller may control the memory device 150 in response to a request from the host 102. The controller 130 may provide the data read from the memory device 150, to the host 102, and/or may store the data provided from the host 102 into the memory device 150.

For example, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, For example, power for the component elements included in the controller 130.

The NEC 142 may serve as a memory interface between the controller 130 and the memory device 150 to allow the controller 130 to control the memory device 150 in response to a request from the host 102. The NEC 142 may generate control signals for the memory device 150 and process data under the control of the processor 134 when the memory device 150 is a flash memory and, for example, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

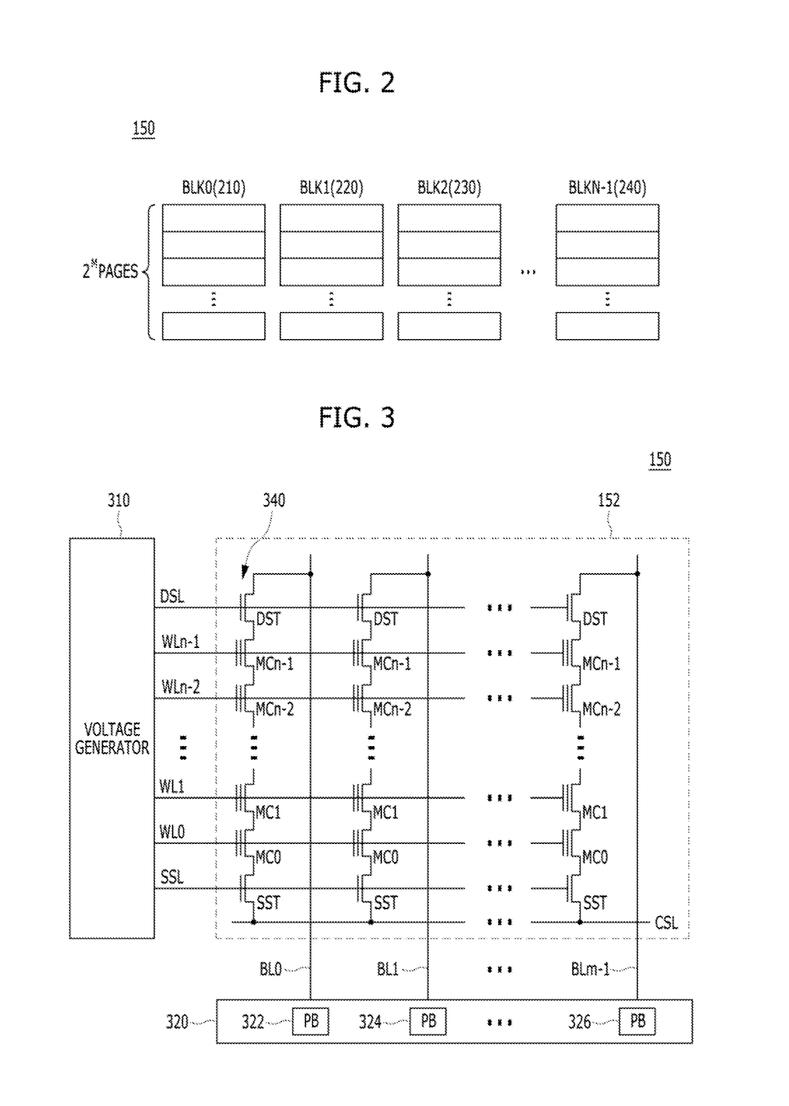

FIG. 2 is a schematic diagram illustrating the memory device 150 shown in FIG. 1.

Referring to FIG. 2, the memory device 150 may include a plurality of memory blocks, for example, zeroth to (N−1)^{th} blocks 210 to 240. Each of the plurality of memory blocks 210 to 240 may include a plurality of pages, for example, 2^{M} number of pages (2^{M} PAGES). Each of the plurality of pages may include a plurality of memory cells to which a plurality of word lines are electrically coupled.

The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

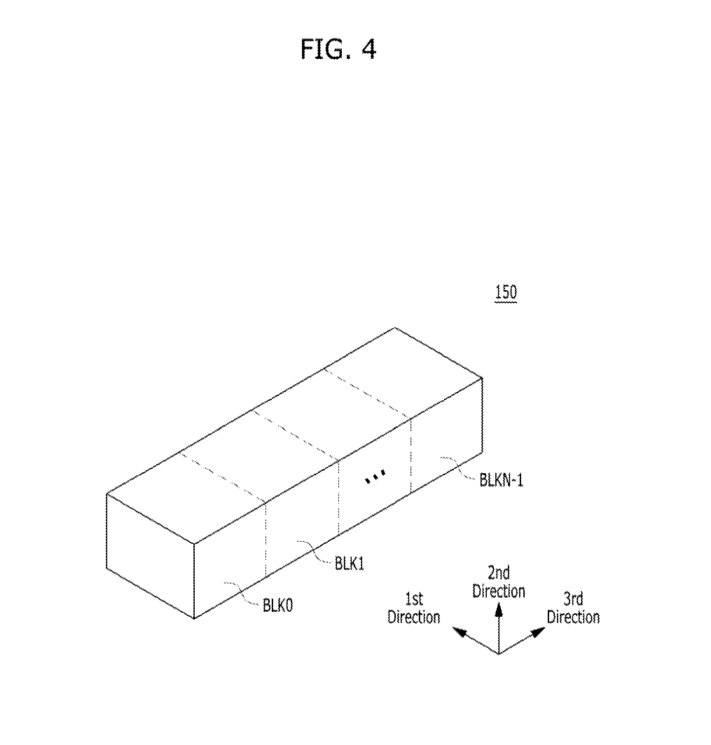

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm-1 respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by multi-level cells (MLC) each of which stores data information of a plurality of bits. The respective memory cells MC0 to MCn-1 may be configured by single-level cells (SLC) each of which may store a single bit. The strings 340 may be electrically coupled to the corresponding bit lines BL0 to BLm-1, respectively. For reference, in FIG. 3, ‘DSL’ denotes a drain select line, ‘SSL’ denotes, a source select line, a ‘CSL’ denotes a common source line.

While FIG. 3 shows, as an example, the memory block 152 which is configured by NAND flash memory cells, it is to be noted that the memory block 152 is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. During a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted or retrieved data. For example, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

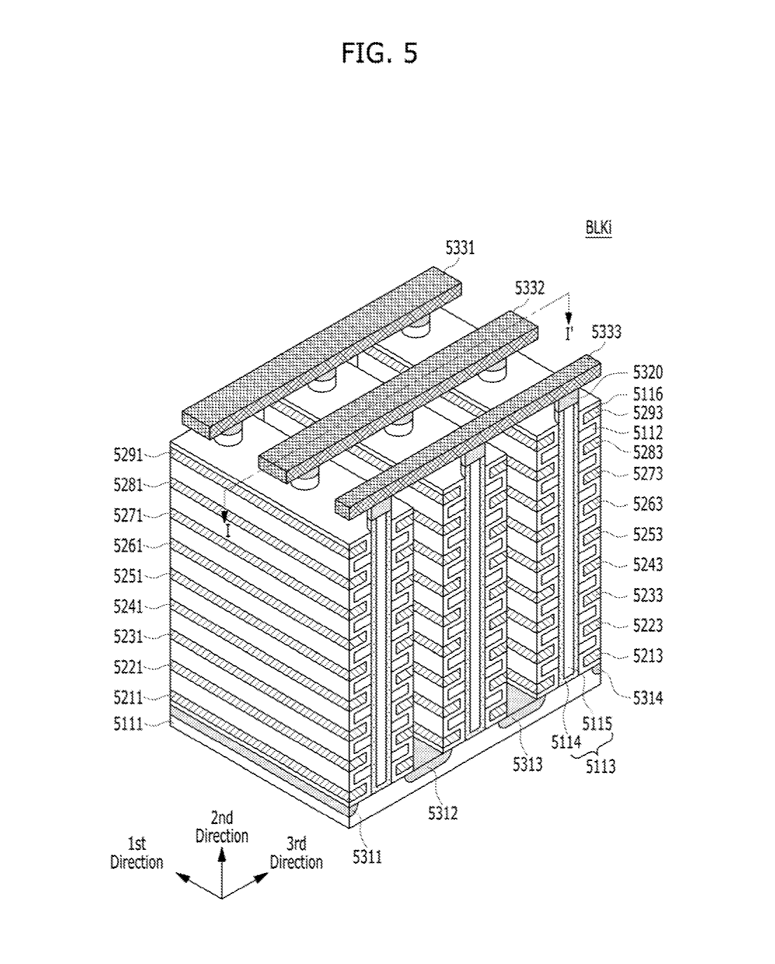

FIGS. 4 to 11 are schematic diagrams illustrating various aspects of the memory device 150 shown in FIG. 1.

FIG. 4 is a block diagram illustrating an example of the plurality of memory blocks 152 to 156 of the memory device 150 shown in FIG. 1.

Referring now to FIG. 4, the memory device 150 may include a plurality of memory blocks BLK0 to BLKN-1, and each of the memory blocks BLK0 to BLKN-1 may be realized in a three-dimensional (3D) structure or a vertical structure. Each memory block BLK0 to BLKN-1 may include a structure which extends in first to third directions, for example, an x-axis direction, a y-axis direction and a z-axis direction.

The respective memory blocks BLK0 to BLKN-1 may include a plurality of NAND strings NS which extend in the second direction. The plurality of NAND strings NS may be provided in the first direction and the third direction. Each NAND string NS may be electrically coupled to a bit line BL, at least one source select line SSL, at least one ground select line GSL, a plurality of word lines WL, at least one dummy word line DWL, and a common source line CSL. For example, the respective memory blocks BLK0 to BLKN-1 may be electrically coupled to a plurality of bit lines BL, a plurality of source select lines SSL, a plurality of ground select lines GSL, a plurality of word lines WL, a plurality of dummy word lines DWL, and a plurality of common source lines CSL.

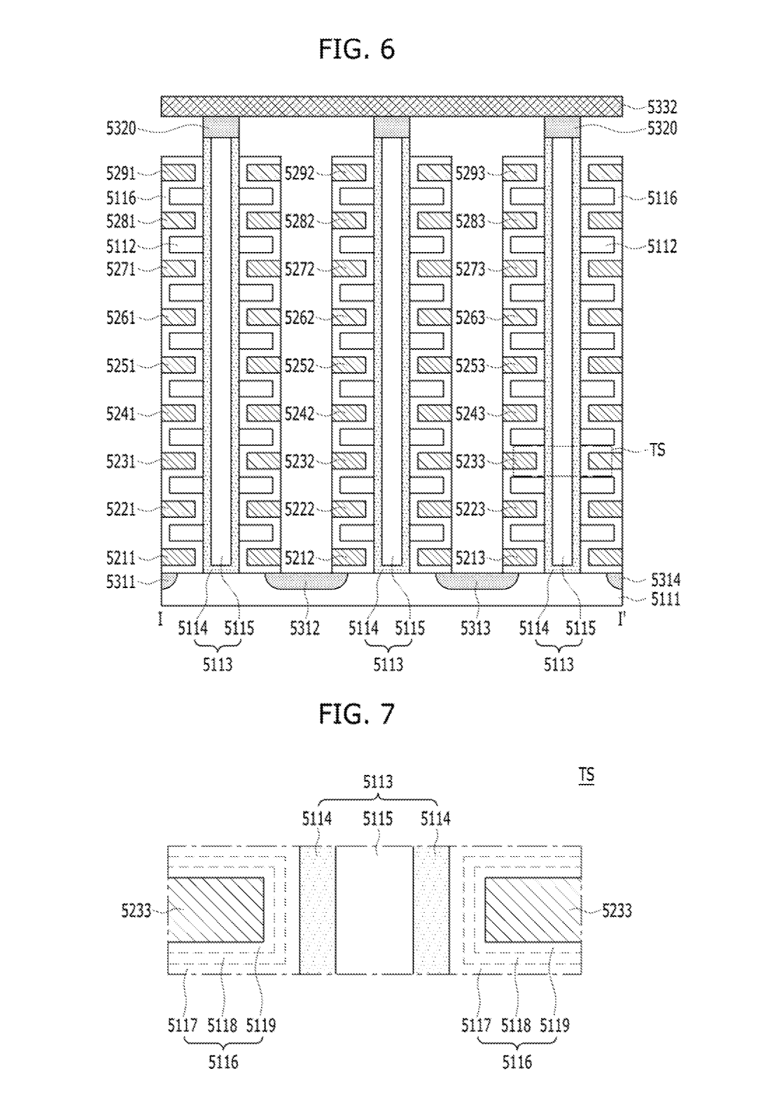

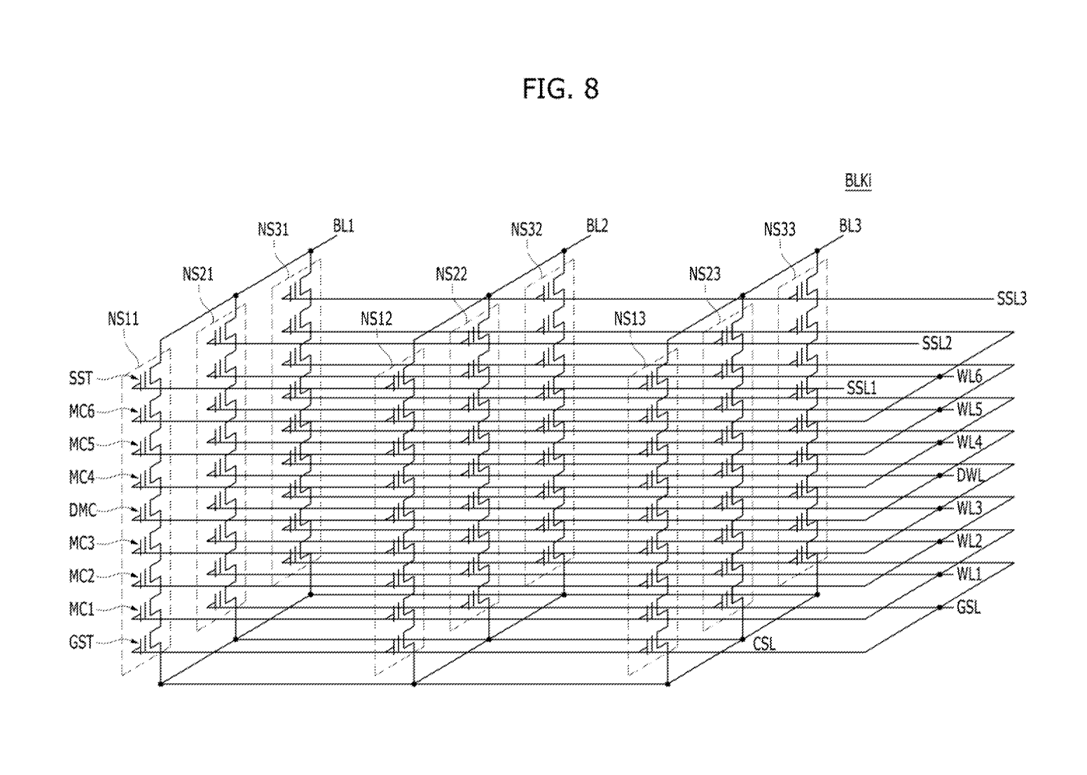

FIG. 5 is a perspective view of one BLKi of the plural memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While in the embodiment described the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the impurity used in the substrate 5111. The plurality of doping regions 5311 to 5314 may be doped with an n-type impurity. While in the embodiment described here first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide. It is to be noted, however, that other suitable dielectric materials may also be used.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While in the embodiment described here the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. For example, a region in which a material other than the dielectric material 5112 and the dielectric layer 5116 may be disposed, may be provided between (I) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. For example, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While in the embodiment described, for the sake of convenience, the drains 5320 include n-type silicon, it is to be noted that the drains 5320 are not limited to being n-type silicon. The width of each drain 5320 may be larger than the width of each corresponding pillar 5113. For example, each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled with through contact plugs. The conductive materials 5331 to 5333 may be a metallic material. The conductive materials 5331 to 5333 may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

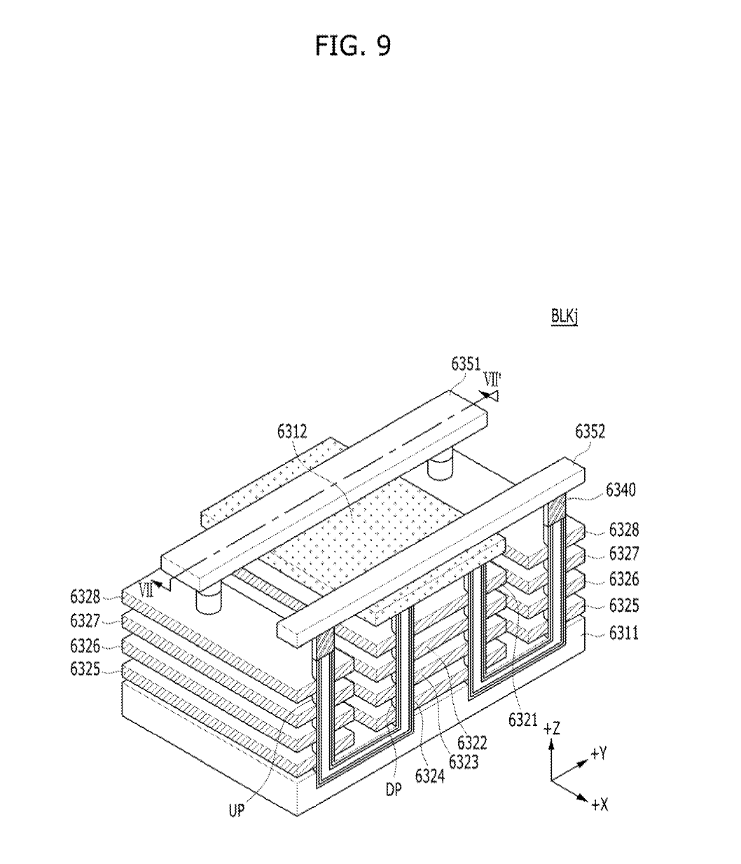

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. For example, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment described, for the sake of convenience, the surface layer 5114 of p-type silicon in each of the pillars 5113 will be referred to as a body in the second direction.

The memory block BLKi may include the plurality of pillars 5113. For example, the memory block BLKi may include the plurality of NAND strings NS. For example, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. For example, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. For example, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

For example, the memory block BLKi may include a plurality of NAND strings NS which extend in a direction perpendicular to the substrate 5111 e.g., the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. For example, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

While it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

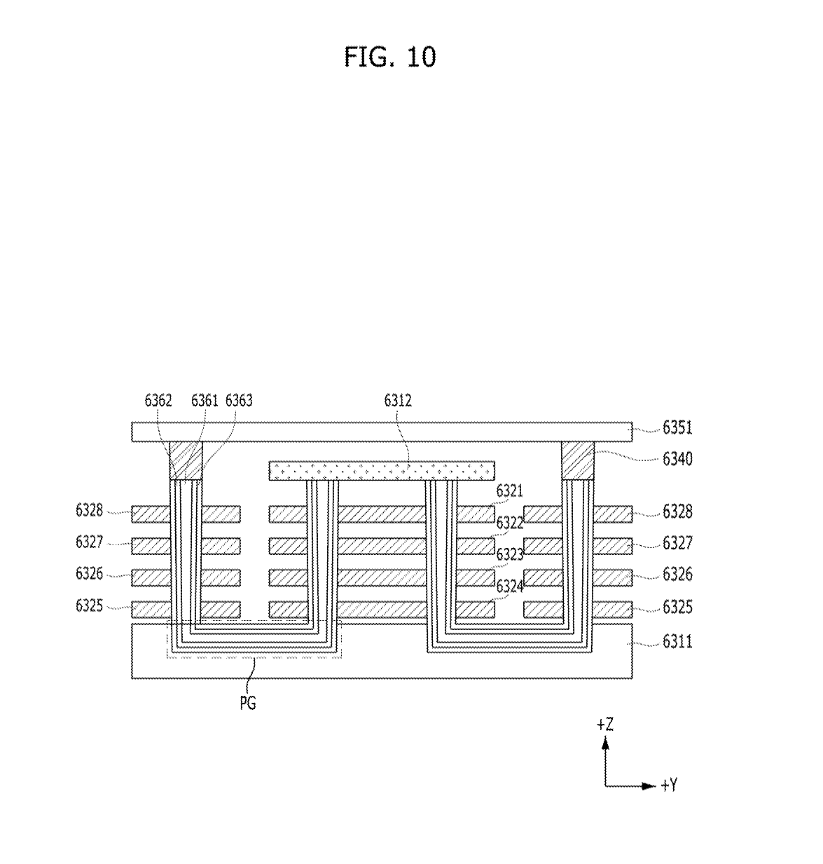

FIG. 8 is an equivalent circuit diagram illustrating the memory block BLKi having a first structure described with reference to FIGS. 5 to 7.

Referring now to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined by units of rows and columns and NAND strings NS which are electrically coupled to one bit line may form one column. The NAND strings NS11 to NS31 which are electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row, and the NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. For example, at the same height, the word lines WL electrically coupled to the memory cells MC of the NAND strings NS in different rows may be electrically coupled. Dummy memory cells DMC at the same height in the NAND strings NS of the same row may share a dummy word line DWL. For example, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 which extend in the first direction may be provided. The conductive materials 5211 to 5291, 5212 to 5292 and 5213 to 5293 which extend in the first direction may be electrically coupled in common to upper layers through contacts. At the upper layers the conductive materials 5211 to 5291, 5212 to 5292 and 5213 to 5293 which extend in the first direction may be electrically coupled. For example, the ground select transistors GST of the NAND strings NS in the same row may share the ground select line GSL. The ground select transistors GST of the NAND strings NS in different rows may share the ground select line GSL. For example, the NAND strings NS11 to NS13, NS21 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled. The first to fourth doping regions 5311 to 5314 may be electrically coupled to an upper layer through contacts and, at the upper layer, the first to fourth doping regions 5311 to 5314 may be electrically coupled.

For example, as shown in FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. For example, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. For example, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

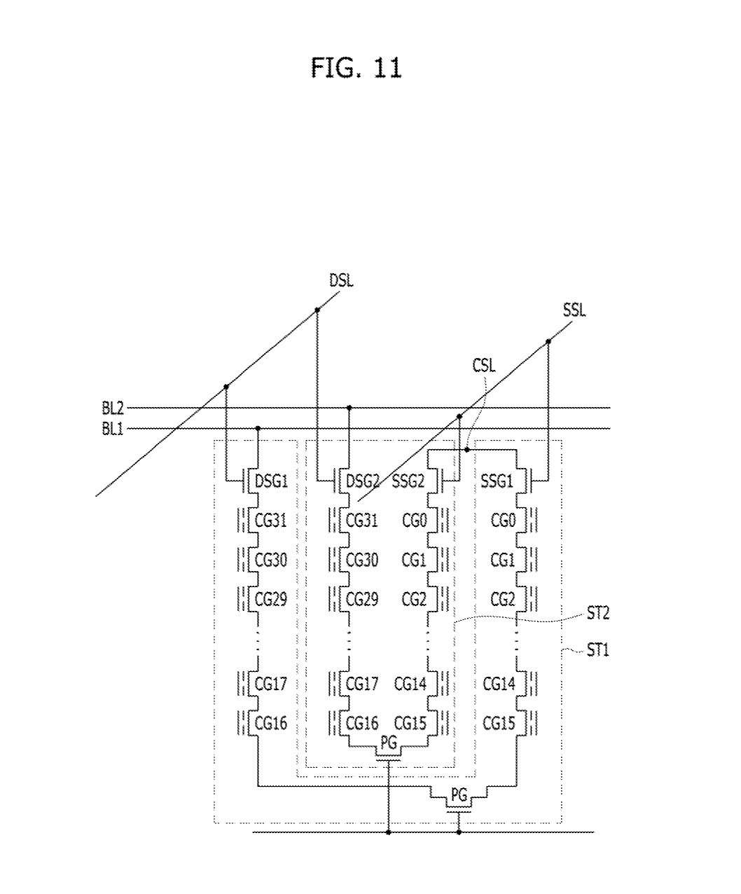

Referring to FIGS. 9 to 11, a memory device in a memory system employing a three-dimensional (3D) nonvolatile memory device is provided, according to an embodiment of the invention.

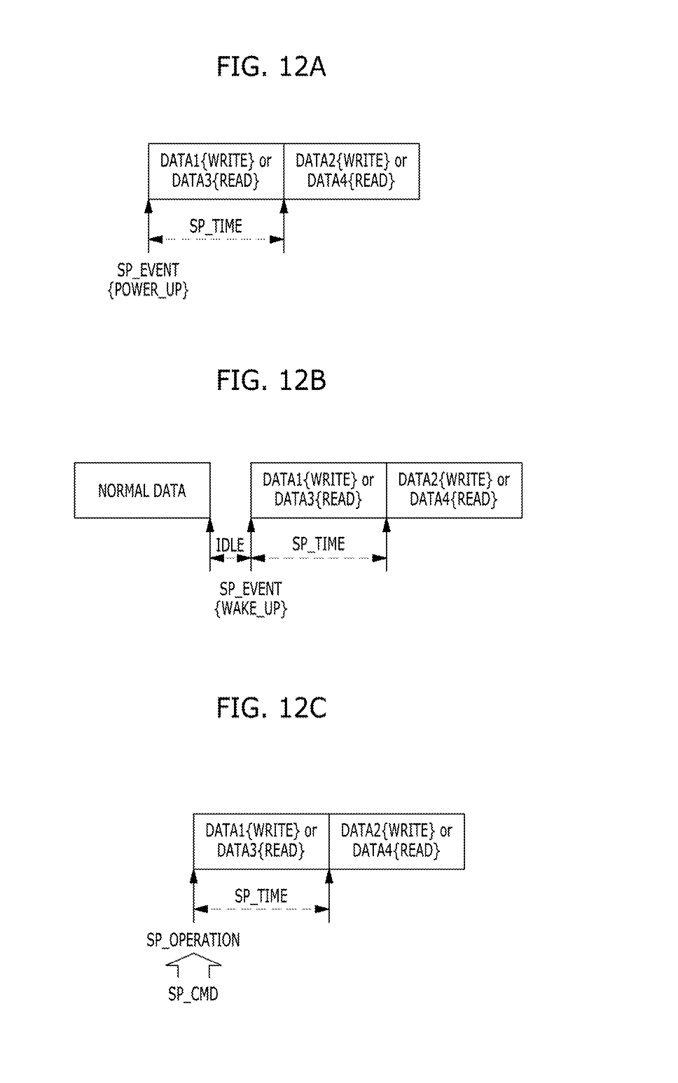

FIG. 9 is a perspective view schematically illustrating the memory device implemented with a three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating the memory block BLKj taken along the line of FIG. 9.

The memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While in the embodiment described, the substrate 6311 is p-type silicon, it is to be noted that the substrate 6311 is not limited to being p-type silicon.

First to fourth conductive materials 6321 to 6324 which extend in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. A plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

For example, the lower string may include a source select transistor SST, the first dummy memory cell DMC1, and the first and second main memory cells MMC1 and MMC2. The upper string may include the third and fourth main memory cells MMC3 and MMC4 the second dummy memory cell DMC2 and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above with reference to FIG. 7, a detailed description thereof will be omitted herein.

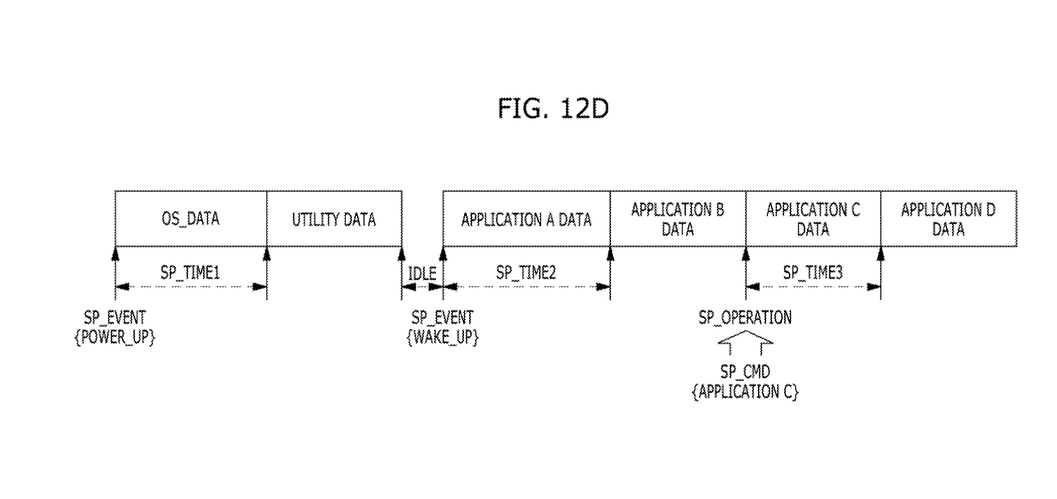

FIG. 11 is a circuit diagram illustrating the equivalent circuit of the memory block BLKj having the second structure as described above with reference to FIGS. 9 and 10. For the sake of convenience, only a first string and a second string, which form a pair in the memory block BLKj in the second structure are shown.

Referring to FIG. 11, in the memory block BLKj having the second structure among the plurality of blocks of the memory device 150, cell strings, each of which is implemented with one upper string and one lower string electrically coupled through the pipe gate PG as described above with reference to FIGS. 9 and 10, may be provided in such a way as to define a plurality of pairs.

For example, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first string ST1 and the second string ST2 may be electrically coupled to the same drain select line DSL and the same source select line SSL. The first string ST1 may be electrically coupled to a first bit line BL1, and the second string ST2 may be electrically coupled to a second bit line BL2.

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. It may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

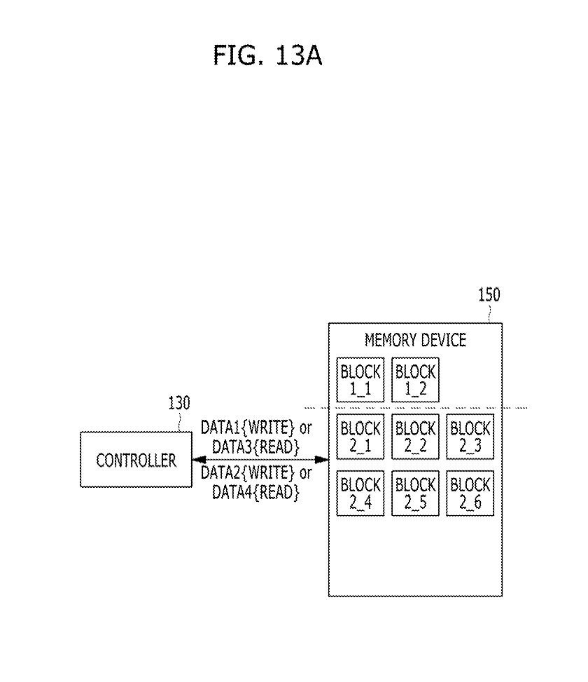

FIGS. 12A to 12D are diagrams an operation of the memory system 100 according to an embodiment of the invention.

Referring now to FIGS. 12A to 12C, the memory system 100 according to an embodiment of the invention classifies data, which is inputted or retrieved from a host 102 and is stored within a preset period of time SP_TIME from occurrence of a preset event SP_EVENT, as first data DATA1, and classifies data, which is inputted or retrieved from the host 102 and is stored after the preset period of time SP_TIME measured from occurrence of the preset event SP_EVENT, as second data DATA2. The memory system 100 classifies data, which is read to the host 102 within the preset period of time SP_TIME from the occurrence of the preset event SP_EVENT, as third data DATA3, and classifies data, which is read to the host 102 after the preset period of time SP_TIME measured from occurrence of the preset event SP_EVENT, as fourth data DATA4.

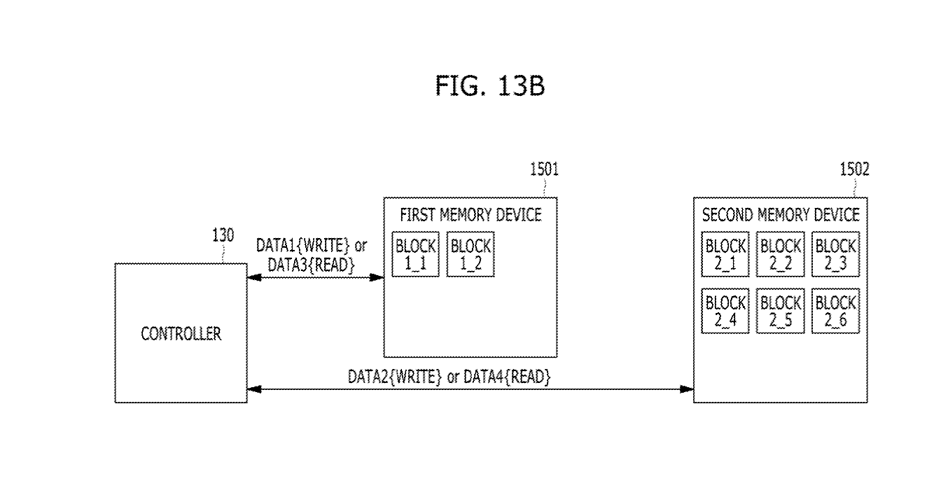

Memory spaces, in which the first data DATA1 is stored and the third data DATA3 is read, are set to be different from memory spaces, in which the second data DATA2 is stored and the fourth data DATA4 is read. Memory spaces that are different from each other are described for example in the embodiment of FIG. 13.

The preset event SP_EVENT may be a power-up POWER_UP event performed when power is firstly supplied to the memory system 100 as illustrated in FIG. 12A. For example, after the power-up POWER_UP event occurs, data inputted or retrieved from the host 102 and stored within the preset period of time SP_TIME is classified as the first data DATA1, and data inputted or retrieved from the host 102 and stored after the preset period of time SP_TIME is classified as the second data DATA2. Similarly, after the power-up POWER_UP event occurs, data read to the host 102 within the preset period of time SP_TIME is classified as the third data DATA3, and data read to the host 102 after the preset period of time SP_TIME is classified as the fourth data DATA4.

The preset event SP_EVENT may be a wake-up WAKE_UP event performed when the memory system starts to operate again after an idle state IDLE as illustrated in FIG. 12B. For example, after the wake-up WAKE_UP event occurs, data inputted or retrieved from the host 102 and stored within the preset period of time SP_TIME is classified as the first data DATA1, and data inputted or retrieved from the host 102 and stored after the preset period of time SP_TIME is classified as the second data DATA2. Similarly, after the wake-up WAKE_UP event occurs, data read to the host 102 within the preset period of time SP_TIME is classified as the third data DATA3, and data read to the host 102 after the preset period of time SP_TIME is classified as the fourth data DATA4.

The preset event SP_EVENT may be a predetermined operation SP_OPERATION performed in response to a predetermined command SP_CMD transferred from the host 102 as illustrated in FIG. 12C. After the predetermined operation SP_OPERATION commences, data inputted or retrieved from the host 102 and stored within the preset period of time SP_TIME is classified as the first data DATA1, and data retrieved from the host 102 and stored after the preset period of time SP_TIME is classified as the second data DATA2. Likewise, after the predetermined operation SP_OPERATION commences, data read to the host 102 within the preset period of time SP_TIME is classified as the third data DATA3, and data read to the host 102 after the preset period of time SP_TIME is classified as the fourth data DATA4.

Referring now to FIG. 12D, an example of an entire operation for classifying data is described with reference to FIG. 12A to 12C as may be needed.

After power is initially supplied to the memory system 100 and the power-up POWER_UP event occurs, the memory system classifies data inputted or retrieved from the host 102 and stored or read to the host 102 within a first preset period of time SP_TIME1 as operating system data OS_DATA, and classifies data inputted or retrieved from the host 102 and stored or read to the host 102 after the first preset period of time SP_TIME1 as utility data UTILITY DATA.

The operating system data OS_DATA, for example, may include data used in a booting operation of an operating system in the host 102.

The utility data UTILITY DATA, for example, may include utility data executed in a secondary operation during a normal operation of the operating system or user data selectively executed in the normal operation of the operating system.

After the utility data UTILITY DATA is inputted/outputted to/from the host 102, the memory system 100 enters the idle state IDLE and the wake-up WAKE_UP event occurs after the idle state IDLE.

After the wake-up WAKE_UP event occurs, the memory system classifies data inputted or retrieved from the host 102 and stored or read to the host 102 within a second preset period of time SP_TIME2 as ‘A’ application data APPLICATION A DATA, and classifies data inputted or retrieved from the host 102 and stored or read to the host 102 after the second preset period of time SP_TIME2 as ‘B’ application data APPLICATION B DATA.

When a predetermined command SP_CMD is inputted or retrieved from the host 102 while the ‘B’ application data APPLICATION B DATA is being inputted/outputted to/from the host 102, the predetermined operation SP_OPERATION is performed in response to the predetermined command SP_CMD. After the predetermined operation SP_OPERATION is initiated, the memory system classifies data inputted or retrieved from the host 102 and stored or read to the host 102 within a third preset period of time SP_TIME3 as ‘C’ application data APPLICATION C DATA, and classifies data inputted or retrieved from the host 102 and stored or read to the host 102 after the third preset period of time SP_TIME3 as ‘D’ application data APPLICATION D DATA.

The ‘A’ application data APPLICATION A DATA, the ‘B’ application data APPLICATION B DATA, the ‘C’ application data APPLICATION C DATA, and the ‘D’ application data APPLICATION D DATA may be different from one another and may also different form data used in the host 102.

As described above, the operating system data OS_DATA and the utility data UTILITY DATA are classified with reference to the first preset period of time SP_TIME1, the ‘A’ application data APPLICATION A DATA and the ‘B’ application data APPLICATION B DATA are classified with reference to the second preset period of time SP_TIME2, and the ‘C’ application data APPLICATION C DATA and the ‘D’ application data APPLICATION D DATA are classified with reference to the third preset period of time SP_TIME3.

The first preset period of time SP_TIME1, the second preset period of time SP_TIME2, and the third preset period of time SP_TIME3 are different from one another. For example, the second preset period of time SP_TIME2 is set as longest, the third preset period of time SP_TIME3 is set as shortest, and the first preset period of time SP_TIME1 is set as intermediate.

As described above, the reason for differently setting the respective preset periods of time SP_TIME<1:3> is because their reference events are different from one another. For example, the length of the first preset period of time SP_TIME1 is decided with reference to the power-up POWER_UP event, the length of the second preset period of time SP_TIME2 is decided with reference to the wake-up WAKE_UP event, and the length of the third preset period of time SP_TIME3 is decided with reference to the execution of the predetermined operation SP_OPERATION.

The respective preset periods of time SP_TIME 1:3> may be set to have various lengths. For example, the respective preset periods of time SP_TIME<1:3> may be changed according to an environment in which the memory system is used. The respective preset period of time SP_TIME<1:3> may be set by the memory system 100 or the host 102.

FIGS. 13A and 13B are diagrams of a memory system 100 according to an embodiment of the invention.

Referring to FIG. 13A, the plurality of memory blocks 152 to 156 included in the memory device 150 of FIG. 1 are classified into a first block group BLOCK1_1 and BLOCK1_2 and a second block group BLOCK2_1, BLOCK2_2, BLOCK2_3, BLOCK2_4, BLOCK2_5, and BLOCK2_6.

For example, referring now to FIGS. 12A to 12D and 13A, the controller 130 stores the first data DATA1, which is inputted or retrieved from the host 102 within the preset period of time SP_TIME from the occurrence of the preset event SP_EVENT, in the first block group BLOCK1_1 and BLOCK1_2. The controller 130 stores the second data DATA2, which is inputted or retrieved from the host 102 after the preset period of time SP_TIME from the occurrence of the preset event. SP_EVENT, in the second block group BLOCK2_1, BLOCK2_2, BLOCK2_3, BLOCK2_4, BLOCK2_5, and BLOCK2_6.

Then, the controller 130 preferentially searches for the third data DATA3, which is read to the host 102 within the preset period of time SP_TIME from the occurrence of the preset event SP_EVENT, in the first block group BLOCK1_1 and BLOCK1_2. When the third data DATA3 does not exist in the first block group BLOCK1_1 and BLOCK1_2 the controller 130 searches for the third data DATA3 in the second block group BLOCK2_1, BLOCK2_2, BLOCK2_3, BLOCK2_4, BLOCK2_5, and BLOCK2_6. The controller 130 preferentially searches for the fourth data DATA4, which is read to the host 102 after the preset period of time SP_TIME from the occurrence of the preset event SP_EVENT, in the second block group BLOCK2_1, BLOCK2_2, BLOCK2_3, BLOCK2_4, BLOCK2_5, and BLOCK2_6. When the fourth data DATA4 does not exist in the second block group BLOCK2_1, BLOCK2_2, BLOCK2_3, BLOCK2_4, BLOCK2_5, and BLOCK2_6, the controller 130 searches for the fourth data DATA4 in the first block group BLOCK1_1 and BLOCK1_2.

As described above, the controller 130 inputs/outputs the first data DATA1 and the third data DATA3 to/from the first block group BLOCK1_1 and BLOCK1_2 in the memory device 150, and inputs/outputs the second data DATA2 and the fourth data DATA4 to/from the second block group BLOCK2_1, BLOCK2_2, BLOCK2_3, BLOCK2_4, BLOCK2_5, and BLOCK2_6. In this case, the memory space of the first block group BLOCK1_1 and BLOCK1_2 is separated from the memory space of the second block group BLOCK2_1, BLOCK2_2, BLOCK2_3, BLOCK2_4, BLOCK2_5, and BLOCK2_6. Accordingly, a first address for the first data DATA1 and the third data DATA3 and a second address for the second data DATA2 and the fourth data DATA4 are separately managed by the controller 130. For example, the first address represents the first block group BLOCK1_1 and BLOCK1_2 and the second address represents the second block group BLOCK2_1, BLOCK2_2, BLOCK2_3, BLOCK2_4, BLOCK2_5, and BLOCK2_6.

The first address and the second addresses are separately managed through different address map tables. The first address and the second address are separately managed through a single address map table. The address map table stores mapping information of physical addresses and corresponding logical addresses.

The first and third DATA1 and DATA3 and the second and fourth DATA2 and DATA4 may be differently used from each other.

Accordingly, the controller 130 allows a scheme of storing the first data DATA1 in the first block group BLOCK1_1 and BLOCK1_2 to be different from a scheme of storing the second data DATA2 in the second block group BLOCK2_1, BLOCK2_2, BLOCK2_3, BLOCK2_4, BLOCK2_5, and BLOCK2_6, thereby allowing the first data DATA1 and the second data DATA2 to be stored differently and therefore may have different reliabilities.

For example, as described in FIG. 12D, the operating system data OS_DATA corresponding to the first data DATA1 may be stored with relatively high reliability, and the utility data UTILITY DATA corresponding to the second data DATA2 may be stored with relatively low reliability. For example, a memory cell included in the first block group BLOCK1_1 and BLOCK1_2 may be a single level cell (SLC) to store the first data DATA1 and a memory cell included in the second block group BLOCK2_1, BLOCK2_2, BLOCK2_3, BLOCK2_4, BLOCK2_5, and BLOCK2_6 may be a multilevel cell (MLC) to store the second data DATA2.

Similarly, the controller 130 may differently set attributes of the first block group BLOCK1_1 and BLOCK1_2 and the second block group BLOCK2_1, BLOCK2_2, BLOCK2_3, BLOCK2_4, BLOCK2_5, and BLOCK2_6 in consideration of access frequencies between the third data DATA3 and the fourth data DATA4.

For example, as described in FIG. 12D, the operating system data OS_DATA corresponding to the third data DATA3 may be set to have relatively low access frequency, and the utility data UTILITY DATA corresponding to the fourth data DATA4 may be set to have relatively high access frequency. For example, the controller 130 may set the first block group BLOCK1_1 and BLOCK1_2 as a cold block group or the controller may set the second block group BLOCK2_1, BLOCK2_2, BLOCK2_3, BLOCK2_4, BLOCK2_5, and BLOCK2_6 as a hot block group.

Referring now to FIG. 13B, the memory system 110 shown in FIG. 13B may be the same as the memory system 110 described with reference to FIG. 13A except that the memory system 110 shown in FIG. 13B includes separate memory devices 1501 and 1502 comprising the first block group BLOCK1_1 and BLOCK1_2 and the second block group BLOCK2_1, BLOCK2_2, BLOCK2_3, BLOCK2_4, BLOCK2_5, and BLOCK2_6, respectively.

For example, referring to FIG. 13B, the controller 130 may allow an operation speed of the first memory device 1501 to be different from an operation speed of the second memory device 1502 taking into account the access frequencies between the third data DATA3 and the fourth data DATA4.

For example, the second memory device 1502 may operate at a speed that is relatively faster than that of the first memory device 1501. For example, the first memory device 1501 may be a NAND flash memory device of relatively low operation speed and the second memory device 1502 may be a PCRAM memory device of relatively high operation speed.

As described above, according to an embodiment of the invention, data inputted or retrieved from a host within a preset period of time from the time point at which a preset event occurs and data inputted or retrieved from the host after the preset period of time are stored in spaces different from each other. Consequently, it is possible to more readily identify the type of data inputted or retrieved from the host and manage data processing more effectively.

Although various embodiments have been described for illustrative purposes, it will be apparent to those skilled in the art that various changes and modifications may be made without departing from the spirit and scope of the invention as defined in the following claims.

What is claimed:

1. A memory system comprising:
a memory device including a first block group and a second block group; and
a controller suitable for storing first data in the first block group, and storing second data in the second block group,
wherein the first data is provided within a preset period of time measured from occurrence of a preset event, and the second data is provided after the preset period of time is expired.

2. The memory system of claim 1,
wherein the controller reads out third data by preferentially searching for the third data in the first block group and then in the second block group,
wherein the controller reads out fourth data by sequentially searching for the fourth data first in the second block group and then in the first block group,
wherein the third data is read out after the preset period of time, and
wherein the fourth data is read out after the preset period of time is expired.

3. The memory system of claim 2, wherein the controller separately manages a first address for the first and third data and a second address for the second and fourth data.

4. The memory system of claim 1, wherein the preset event is a power-up event.

5. The memory system of claim 1, wherein the preset event is a wake-up event.

6. The memory system of claim wherein the preset event is the start of a predetermined operation.

7. The memory system of claim 2, wherein the first block group stores the first and third data with higher reliability than the second block group stores the second and fourth data.

8. The memory system of claim 1,
wherein the first block group includes a single level cell, and
wherein the second block group includes a multilevel cell.

9. The memory system of claim 1,
wherein the first block group is a cold block group, and
wherein the second block group is a hot block group.

10. The memory system of claim
wherein the first and third data are used during a boosting operation of an operating system, and
wherein the second and fourth data are utility data executed in a background during a normal operation of the operating system or user data selectively executed in the normal operation of the operating system.

11. A memory system comprising:
a first memory device;
a second memory device; and
a controller suitable for storing first data in the first memory device, and storing second data in the second memory device,
wherein the first data is provided within a preset period of time measured from occurrence of a preset event, and
wherein the second data is provided after the preset period of time measured from occurrence of the preset event.

12. The memory system of claim 11,
wherein the controller reads out third data by sequentially searching for the third data in the first memory device first and then in the second memory device,
wherein the controller reads out fourth data by sequentially searching for the fourth data in the second memory device first and then in the first memory device,
wherein the third data is read out within the preset period of time, and
wherein the fourth data is read out after the preset period of time is expired.

13. The memory system of claim 12, wherein the controller separately manages a first address for the first and third data and a second address for the second and fourth data.

14. The memory system of claim 11, wherein the preset event is a power-up event.

15. The memory system of claim 11, wherein the preset event is a wake-up event.

16. The memory system of claim 11, wherein the preset event is start of a predetermined operation.

17. The memory system of claim 12, wherein the first memory device stores the first and third data with higher reliability than the second memory device stores the second and fourth data.

18. The memory system of claim 11,
wherein the first memory device includes a single level cell, and
wherein the second memory device includes a multilevel cell.

19. The memory system of claim 12, wherein the first memory device has higher operation speed than the second memory device.

20. The memory system of claim 12,
wherein the first and third data are used during a boosting operation of an operating system, and
wherein the second and fourth data are utility data executed in a background during a normal operation of the operating system or user data selectively executed in the normal operation of the operating system.
